(19) United States
(12) Patent Application Publication
(10) Pub. No.: US 2018/0056486 A1
(43) Pub. Date: Mar. 1, 2018

(54) CLAMPING DEVICE FOR CLAMPING SOFT SHEETS

(71) Applicant: ORIX ENTERPRISE CO., LTD., TAICHUNG CITY (TW)

(72) Inventor: Eric LIAO, TAICHUNG CITY (TW)

(21) Appl. No.: 15/668,701

(22) Filed: Aug. 4, 2017

(30) Foreign Application Priority Data
Aug. 30, 2016 (TW) 105127776

(51) Int. Cl. B25B 5/16; B25B 5/04

(52) U.S. Cl. CPC B25B 5/163; B25B 5/04

(57) ABSTRACT

A clamping device for clamping soft sheets includes: a body, a first clamping member and a second clamping member. The first and second clamping members are affixed to the body and pivotable in opposite directions. The second clamping member includes a second toothed section to be engaged with or disengaged from the first toothed section of the first clamping member, and the second toothed section is engaged with the first toothed section in the engaging area, so that, when the soft sheet is clamped between the first and second toothed sections and pulled toward the inserting area, the first and second toothed sections will be engaged with each other in the engaging area to make it difficult for the soft sheet to slip out of the first and second toothed sections, which consequently improves the clamping force for clamping the gripping force for gripping the soft sheet.

### BACKGROUND

### Field of the Invention

The present invention relates to a clamping device, and more particularly to a clamping device for clamping soft sheets.

### Related Prior Art

A clamping device for clamping soft sheets (such as paper, canvas, etc), as shown in FIG. 1, comprises a body 11 and a clamping assembly 12. The body 11 includes a first portion 111, a second portion 112 and a material inserting slot 113 defined by the first and second portions 111, 112. The first portion 111 includes an inclined slideway 114. The second portion 112 includes a toothed clamping surface 115 located in the material inserting slot 113. The clamping assembly 12 is slidably disposed in the slideway 114 and includes a roller 121 movable toward or away from the clamping surface 115. The clamping assembly 12 is selectively movable between a first position and a second position. When in the first position, the clamping assembly 12 extends into the material inserting slot 113, and the roller 121 moves close to the clamping surface 115 to clamp a soft sheet (not shown) inserted in the material inserting slot 113. When in the second position, the roller 121 moves away from the clamping surface 115 to allow pulling of the soft sheet from the material inserting slot 113. However, this clamping device still has the following deficiencies when in actual use.

When the clamping device clamps a soft sheet member, the clamping operation is carried out by the roller 121 pressing against the clamping surface 115. The clamping force of the roller 121 can be adjusted by the changing the elastic force of the elastic member 122. However, the roller 121 and the clamping surface 115 only contact each other, and there is no overlapped structural design between the roller 121 and the clamping surface 115. Therefore, when the soft sheet is clamped in the clamping device and being pulled, the roller 121 and the clamping surface 115 are not interfered with each other, namely, when the pulling force for pulling the soft sheet 13 is larger than the elastic force of the elastic member 122, the soft sheet will be pulled out of the clamping device, which highlights the defect of poor clamping effect.

The present invention has arisen to mitigate and/or obviate the afore-described disadvantages.

### SUMMARY

One objective of the present invention is to provide a clamping device for clamping soft sheets with improved clamping force.

To achieve the above objective, a clamping device for clamping soft sheets in accordance with the present invention, comprises: a body including a first assembly groove, a second assembly groove, and an inserting space between the first and second assembly grooves, wherein the first assembly groove includes a first pivot portion, the second assembly groove includes a second pivot portion, and an imaginary engaging line is defined between the first and second pivot portions to divide the inserting space into an inserting area and an engaging area; a first clamping member affixed to the body, pivotable in a first direction, and including: a first shaft portion pivotally connected to the first pivot portion, and a first toothed clamping portion movable between the first assembly groove and the inserting space, wherein the first toothed clamping portion includes a first toothed section; and a second clamping member affixed to the body, pivotable in a second direction opposite to the first direction, and including: a second shaft portion pivotally connected to the second pivot portion, and a second toothed clamping portion movable between the second assembly groove and the inserting space, wherein the second toothed clamping portion includes a second toothed section to be disengaged from or engaged with the first toothed section in the engaging area.

Preferably, a profile of the first toothed section of the first clamping member is an involute curve, and a profile of the second toothed section of the second clamping member is an involute curve.

Preferably, the clamping device further includes a first elastic member and a second elastic member, wherein the first assembly groove of the body further includes a first bottom surface, the second assembly groove further includes a second bottom surface facing the first bottom surface, the first elastic member includes: a first sleeve portion sleeved onto the first shaft portion, a first abutting section extending from one end of the first sleeve portion to abut against the first bottom surface, and a first inserting section extending from another end of the first sleeve portion to insert in the first toothed clamping portion, the second elastic members includes a second sleeve portion sleeved onto the second shaft portion, a second abutting section extending from one end of the second sleeve portion to abut against the second bottom surface, and a second inserting section extending from another end of the second sleeve portion to insert in the second toothed clamping portion.

Preferably, there are two said first elastic members, and two said second elastic members.

Preferably, the body further includes a positioning end connected to the first assembly groove, and the first toothed clamping portion of the first clamping member includes a positioning recess for engaging with or disengaging from the positioning end.

Preferably, the second clamping member further includes a pulling portion connected to the second toothed clamping portion and located outside the second assembly groove and the inserting space, pulling the pulling portion makes the second clamping member pivot in the first direction to disengage the second toothed section of the second clamping member from the first toothed section.

Preferably, the clamping device further comprises two pivots, one of the pivots is inserted through the first pivot portion of the body and the first shaft portion of the first clamping member, and another one of the pivots is inserted through the second pivot portion of the body and the second shaft portion of the second clamping member.

Preferably, each of the pivots includes a head abutting against an outer surface of the body, an expanded portion connected to the head and inserted in the first pivot portion or the second pivot portion, and a rod portion connected to the expanded portion and inserted the first shaft portion of the first clamping member or the second shaft portion of the second clamping member.

Preferably, each of the pivots includes a head abutting against an outer surface of the body, a rod portion connected to the head and inserted in the first pivot portion of the body and the first shaft portion of the first clamping member or inserted in the second pivot portion of the body and the second shaft portion of the second clamping member, and a riveting portion connected to the rod portion and abutted against another outer surface of the body.

By such arrangements, the first and second clamping members are affixed to the body and pivotable in opposite directions. The second clamping member includes a second toothed section to be engaged with or disengaged from the first toothed section of the first clamping member, and the second toothed section is engaged with the first toothed section in the engaging area, so that, when the soft sheet is clamped between the first and second toothed sections and pulled toward the inserting area, the first and second toothed sections will be engaged with each other in the engaging area to make it difficult for the soft sheet to slip out of the first and second toothed sections, which consequently improves the clamping force for clamping the gripping force for gripping the soft sheet.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a side view of a conventional clamping device for clamping soft sheets;

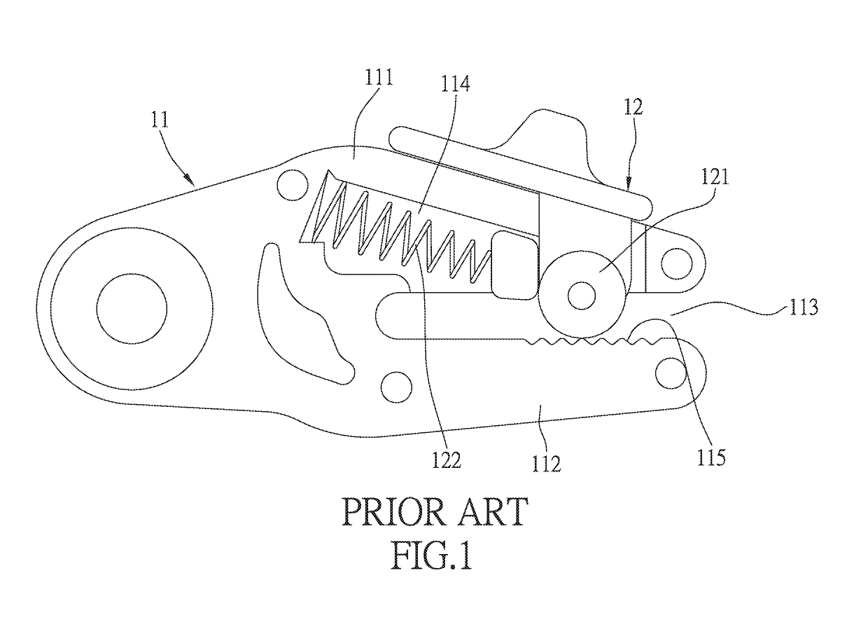

FIG. 2 is an assembly view of a clamping device for clamping soft sheets in accordance with a preferred embodiment of the present invention;

FIG. 3 is an exploded view of the clamping device for clamping soft sheets in accordance with the preferred embodiment of the present invention;

FIG. 4 a transverse cross sectional view of the clamping device for clamping soft sheets in accordance with the preferred embodiment of the present invention;

FIG. 5 is another transverse cross sectional view of the clamping device for clamping soft sheets in accordance with the preferred embodiment of the present invention;

FIG. 6 is a longitudinal cross sectional view of the clamping device for clamping soft sheets in accordance with the preferred embodiment of the present invention;

FIG. 7 is an operational view of the invention, showing that the second toothed section is disengaged from the first toothed section;

FIG. 8 is an operation view of the invention showing that a soft sheet is clamped by the clamping device;

FIG. 9 is an operational view of the invention showing that a soft sheet clamped in the clamping device is being pulled; and

FIG. 10 is a longitudinal cross sectional view of the clamping device for clamping soft sheets in accordance with another preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

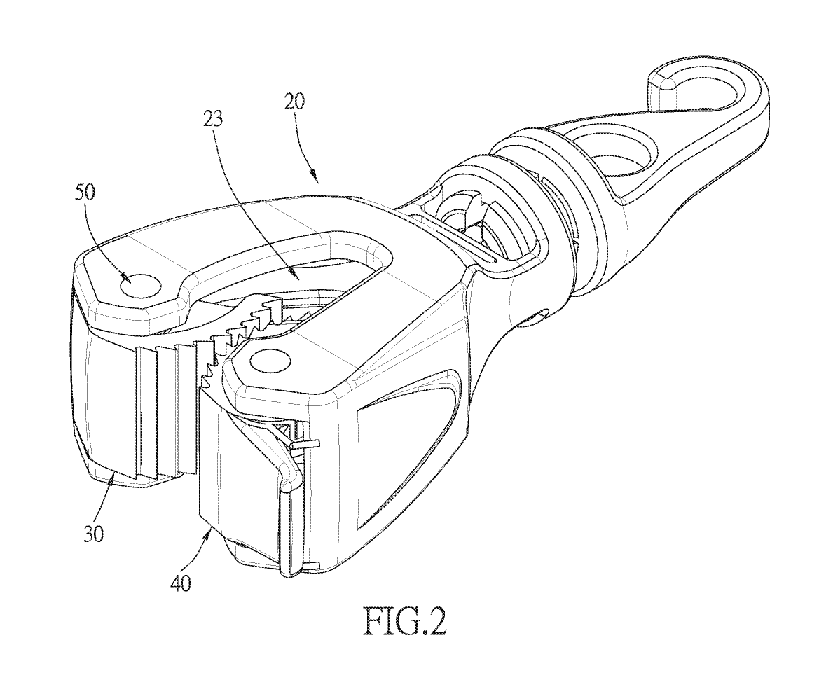

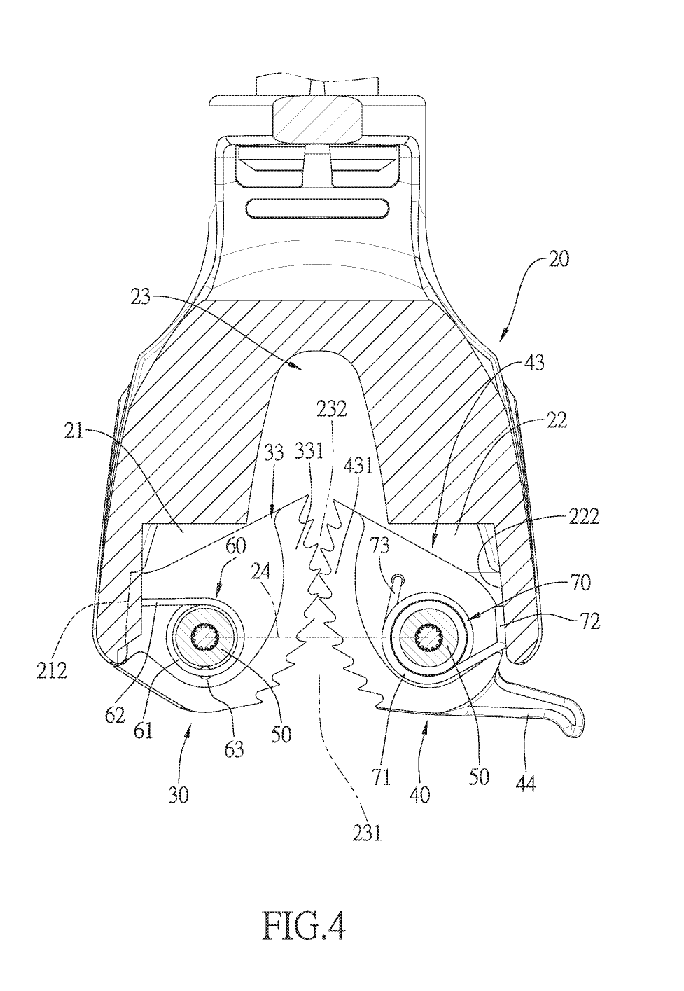

Referring to FIGS. 2-6, the clamping device for clamping soft sheets in accordance with the preferred embodiment of the present invention comprises: a body 20, a first clamping member 30 and a second clamping member 40.

The body 20 includes a first assembly groove 21, a second assembly groove 22, and an inserting space 23 between the first and second assembly grooves 21, 22. The first assembly groove 21 includes a first pivot portion 211, the second assembly groove 22 includes a second pivot portion 221, and an imaginary engaging line 24 is defined between the first and second pivot portions 211, 221 to divide the inserting space 23 into an inserting area 231 and an engaging area 232. In this embodiment, the first assembly groove 21 of the body 20 further includes a first bottom surface 212, and the second assembly groove 22 further includes a second bottom surface 222 facing the first bottom surface 212. The first pivot portion 211 is a hole penetrating two opposite side walls of the first assembly groove 21, and the second pivot portion 221 is a hole penetrating two side walls of the second assembly groove 22.

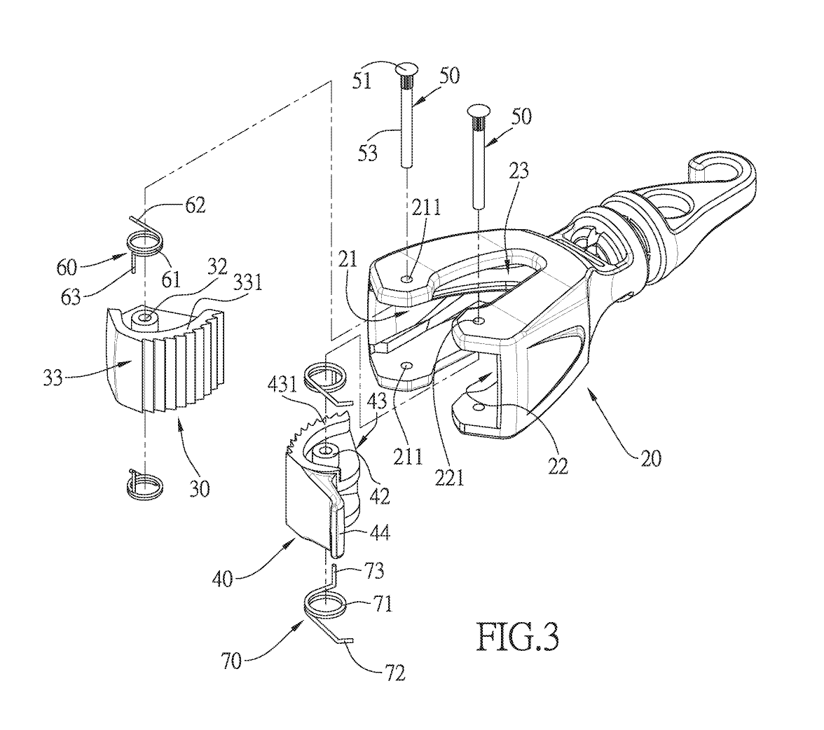

The first clamping member 30 is affixed to the body 20, pivotable in a first direction 31, and includes: a first shaft portion 32 pivotally connected to the first pivot portion 211, and a first toothed clamping portion 33 movable between the first assembly groove 21 and the inserting space 23. The first toothed clamping portion 33 includes a first toothed section 331. In this embodiment, the profile of the first toothed section 331 of the first clamping member 30 is an involute curve as compared to the first shaft portion 32. Besides, the first clamping member 30 is pivotally affixed to the body 20 by a pivot 50 inserted through the first pivot portion 211 of the body 20 and the first shaft portion 32 of the first clamping member 30. The first clamping member 30 is affixed to the body 20 and capable of pivoting in the first direction 31 by virtue of two first elastic members 60. Each of the first elastic members 60 includes: a first sleeve portion 61 sleeved onto the first shaft portion 32, a first abutting section 62 extending from one end of the first sleeve portion 61 to abut against the first bottom surface 212, and a first inserting section 63 extending from another end of the first sleeve portion 61 to insert in the first toothed clamping portion 33. The first direction 31 is a clockwise direction based on FIG. 3.

The second clamping member 40 is affixed to the body 20, pivotable in a second direction 41 which is opposite to the first direction 31, and includes: a second shaft portion 42 pivotally connected to the second pivot portion 221, and a second toothed clamping portion 43 movable between the second assembly groove 22 and the inserting space 23. The second toothed clamping portion 43 includes a second toothed section 431 to be disengaged from or engaged with the first toothed section 331 in the engaging area 232. In this embodiment, the profile of the second toothed section 431 of the second clamping member 40 is an involute curve as compared to the second shaft portion 42. Besides, the second clamping member 40 is pivotally connected to the body 20 by a pivot 50 inserted through the second pivot portion 221 of the body 20 and the second shaft portion 42 of the second clamping member 40. The second clamping member 40 is affixed to the body 20 and capable of pivoting in the second direction 41 by virtue of two second elastic members 70. Each of the second elastic members 70 includes a second sleeve portion 71 sleeved onto the second shaft portion 42, a second abutting section 72 extending from one end of the second sleeve portion 71 to abut against the second bottom surface 222, and a second inserting section 73 extending from another end of the second sleeve portion 71 to insert in the second toothed clamping portion 43. The second direction 41 is a counterclockwise direction based on FIG. 3. The second clamping member 40 further includes a pulling portion 44 connected to the second toothed clamping portion 43 and located outside the second assembly groove 22 and the inserting space 23. Pulling the pulling portion 44 can make the second clamping member 40 pivot in the first direction 31 to disengage the second toothed section 431 from the first toothed section 331.

What mentioned above are the structure relations of the main components of the embodiment, and the operation and function of the invention are as follows.

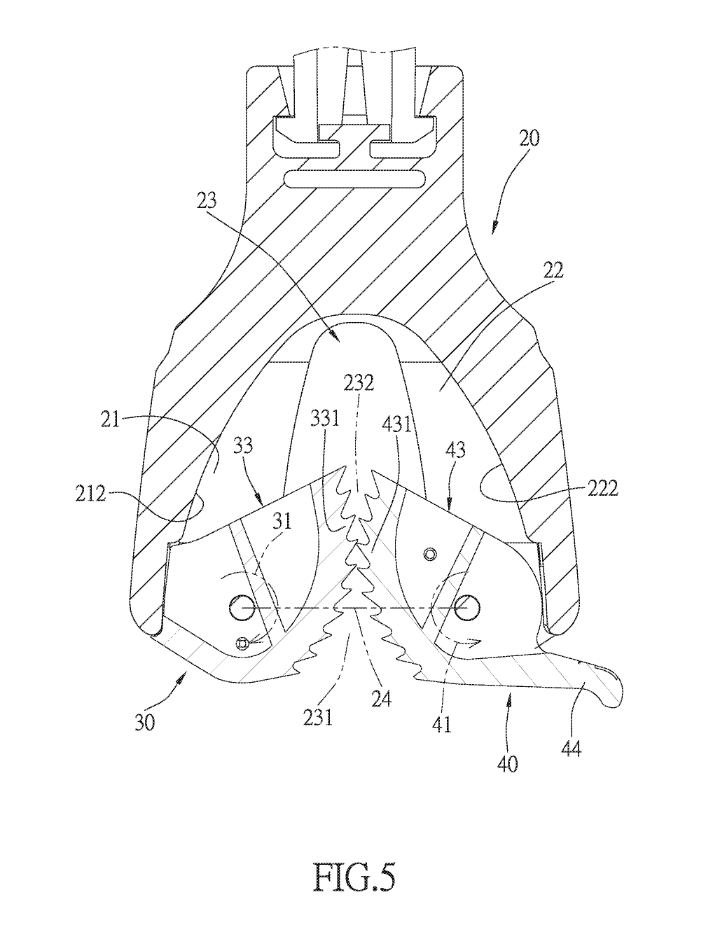

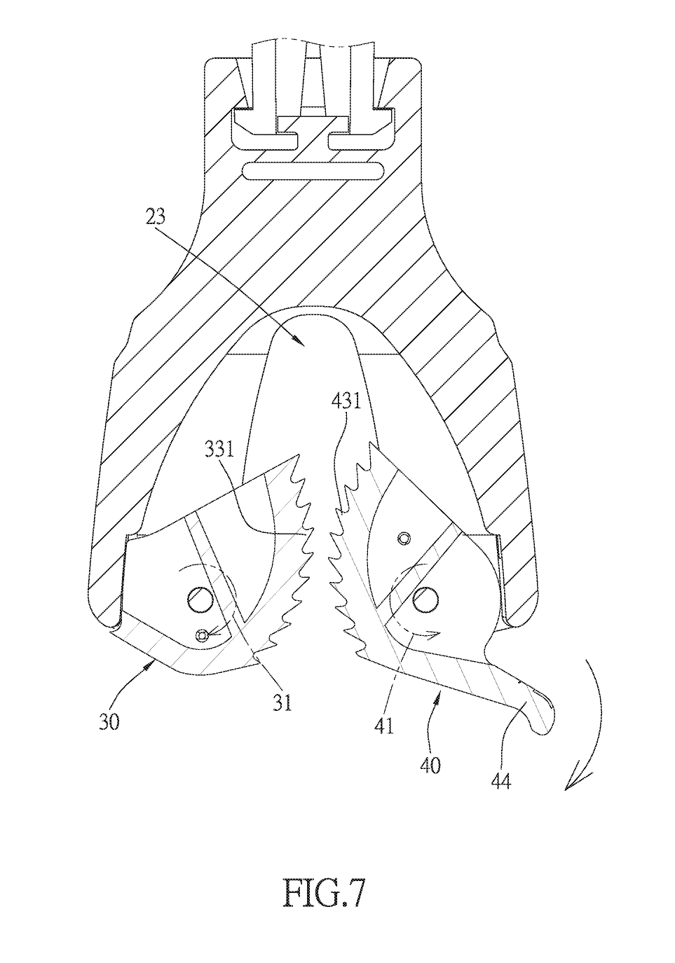

When the invention is used to clamp a soft sheet 90, as shown FIGS. 5 and 7, pulling the pulling portion 44 can make the second clamping member 40 pivot in the first direction 31 (clockwise), so that the second toothed section 431 of the second clamping member 40 will be disengaged from the first toothed section 331 of the first clamping member 30 to produce a clearance for passage of the soft sheet 90.

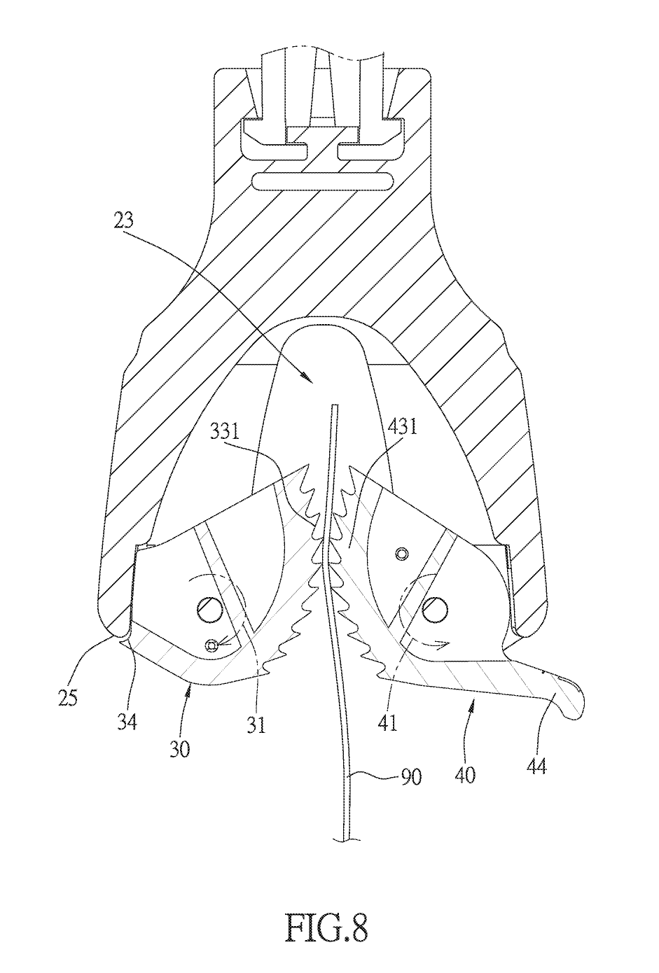

Then, as shown in FIGS. 7 and 8, inserting the soft sheet 90 through the clearance between the first and second clamping members 30, 40 and into the inserting space 23, then releasing the pulling portion 44 to make the second clamping member 40 pivot in the second direction 41 (counterclockwise) by an angle, so that the second toothed section 431 of the second toothed clamping portion 43 and the first toothed section 331 of the first toothed clamping portion 33 will be engaged with each other in the engaging area 232 to clamp the soft sheet 90.

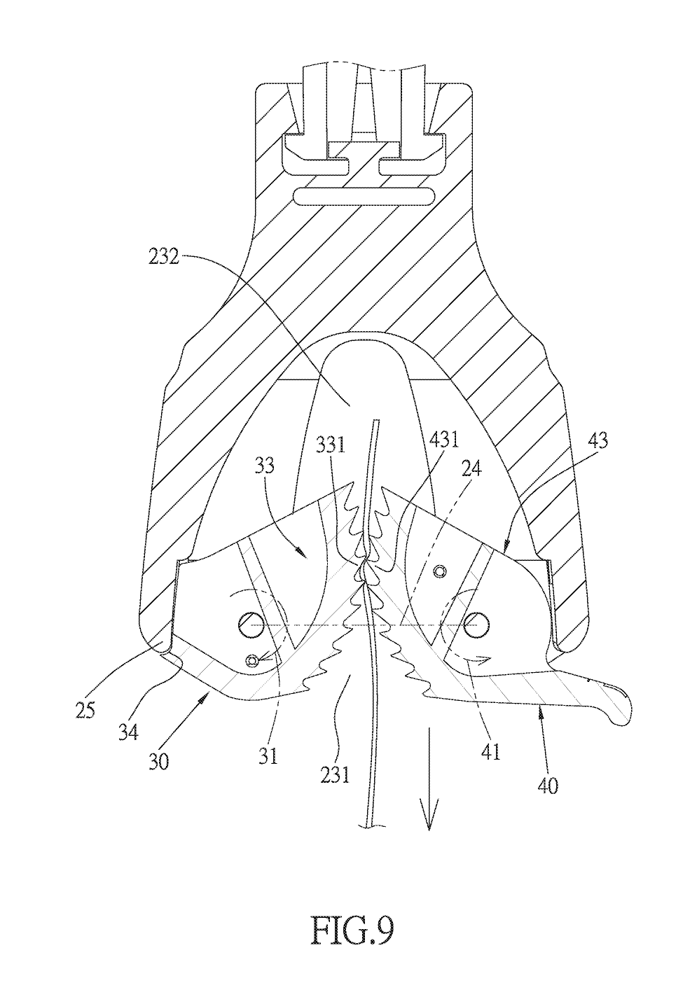

Referring then to FIGS. 8 and 9, when pulled from the engaging area 232 toward the inserting area 231, the soft sheet 90 will drive the first toothed clamping portion 33 of the first clamping member 30 to pivot toward the first direction 31, and drive the second toothed clamping portion 43 of the second clamping member 40 to pivot in the second direction 41, which allows the second toothed section 431 of the second toothed clamping portion 43 to engage more stably with the first toothed section 331 of the first toothed clamping portion 33 in the engaging area 232, making it more difficult for the soft sheet 90 to slip out of the grasp of the first and second toothed sections 331, 431, and thus improving the gripping force for gripping the soft sheet 90.

It is to be noted that the body 20 further includes a positioning end 25 connected to the first assembly groove 21, the first toothed clamping portion 33 of the first clamping member 30 includes a positioning recess 34 for engaging with or disengaging from the positioning end 25. By such arrangements, when the second clamping member 40 pivots an angle in the first direction 31 (clockwise) to disengage the second toothed section 431 of the second clamping member 40 from the first toothed section 331 of the first clamping member 30 by pulling the pulling portion 44, the cooperation of the positioning end 25 of the body 20 with the positioning recess 34 of the first clamping member 30 can prevent the first toothed clamping portion 33 of the first clamping member 30 from pivoting in the first direction 31 to completely move out of the inserting space 23 of the body 20.

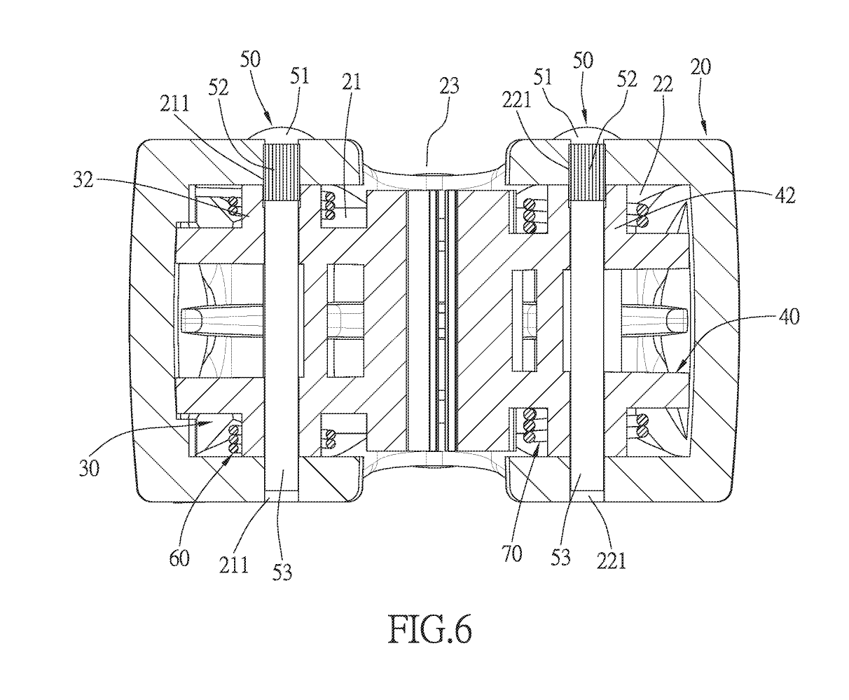

Besides, as shown in FIG. 6, the first and second clamping members 30, 40 are both pivotally affixed to the body 20 by the pivots 50. One of the pivots 50 is inserted through the first pivot portion 211 of the body 20 and the first shaft portion 32 of the first clamping member 30, and another one of the pivots 50 is inserted through the second pivot portion 221 of the body 20 and the second shaft portion 42 of the second clamping member 40. Each of the pivots 50 includes a head 51 abutting against an outer surface of the body 20, an expanded portion 52 connected to the head 51 and inserted in the first pivot portion 211 or the second pivot portion 221, and a rod portion 53 connected to the expanded portion 52 and inserted the first shaft portion 32 of the first clamping member 30 or the second shaft portion 42 of the second clamping member 40.

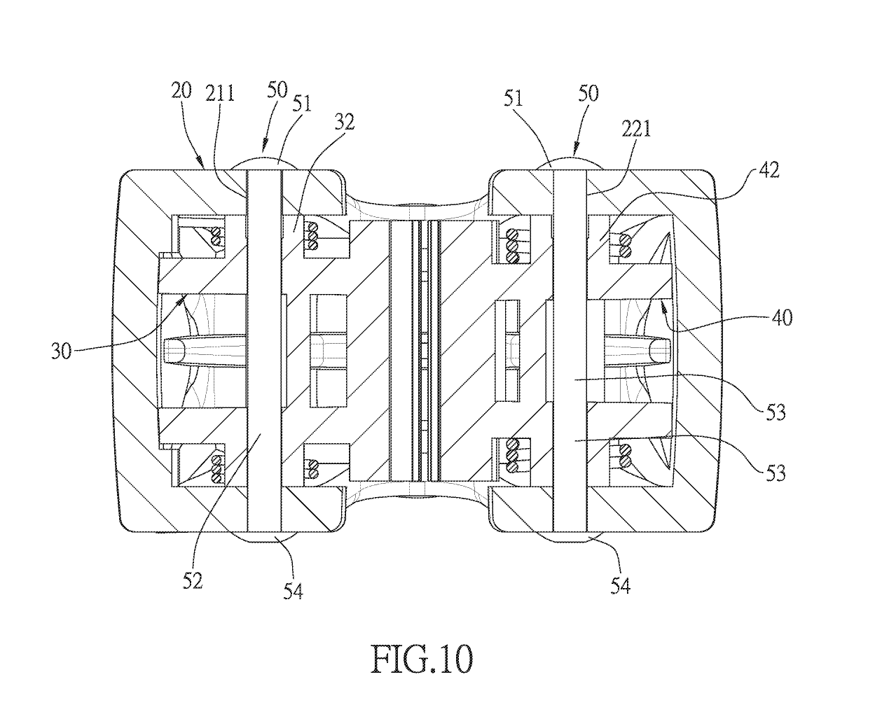

Referring then to FIG. 10, each of the pivots 50 can also include a head 51 abutting against an outer surface of the body 20, a rod portion 53 connected to the head 51 and inserted in the first pivot portion 211 of the body 20 and the first shaft portion 32 of the first clamping member 30 or inserted in the second pivot portion 221 of the body 20 and the second shaft portion 42 of the second clamping member 40, and a riveting portion 54 connected to the rod portion 53 and abutted against another outer surface of the body 20.

While we have shown and described various embodiments in accordance with the present invention, it is clear to those skilled in the art that further embodiments may be made without departing from the scope of the present invention.

What is claimed is:

1. A clamping device for clamping soft sheets, comprising:
a body including a first assembly groove, a second assembly groove, and an inserting space between the first and second assembly grooves, wherein the first assembly groove includes a first pivot portion, the second assembly groove includes a second pivot portion, and an imaginary engaging line is defined between the first and second pivot portions to divide the inserting space into an inserting area and an engaging area;
a first clamping member affixed to the body, pivotable in a first direction, and including: a first shaft portion pivotally connected to the first pivot portion, and a first toothed clamping portion movable between the first assembly groove and the inserting space, wherein the first toothed clamping portion includes a first toothed section; and
a second clamping member affixed to the body, pivotable in a second direction opposite to the first direction, and including: a second shaft portion pivotally connected to the second pivot portion, and a second toothed clamping portion movable between the second assembly groove and the inserting space, wherein the second toothed clamping portion includes a second toothed section to be disengaged from or engaged with the first toothed section in the engaging area.

2. The clamping device for clamping soft sheets as claimed in claim 1, wherein a profile of the first toothed section of the first clamping member is an involute curve, and a profile of the second toothed section of the second clamping member is an involute curve.

3. The clamping device for clamping soft sheets as claimed in claim 1 further comprising a first elastic member and a second elastic member, wherein the first assembly groove of the body further includes a first bottom surface, the second assembly groove further includes a second bottom surface facing the first bottom surface, the first elastic member includes: a first sleeve portion sleeved onto the first shaft portion, a first abutting section extending from one end of the first sleeve portion to abut against the first bottom surface, and a first inserting section extending from another end of the first sleeve portion to insert in the first toothed clamping portion, the second elastic members includes a second sleeve portion sleeved onto the second shaft portion, a second abutting section extending from one end of the second sleeve portion to abut against the second bottom surface, and a second inserting section extending from another end of the second sleeve portion to insert in the second toothed clamping portion.

4. The clamping device for clamping soft sheets as claimed in claim 3, wherein there are two said first elastic members, and two said second elastic members.

5. The clamping device for clamping soft sheets as claimed in claim 1, wherein the body further includes a positioning end connected to the first assembly groove, and the first toothed clamping portion of the first clamping member includes a positioning recess for engaging with or disengaging from the positioning end.

6. The clamping device for clamping soft sheets as claimed in claim 1, wherein the second clamping member further includes a pulling portion connected to the second toothed clamping portion and located outside the second assembly groove and the inserting space, pulling the pulling portion makes the second clamping member pivot in the first direction to disengage the second toothed section of the second clamping member from the first toothed section.

7. The clamping device for clamping soft sheets as claimed in claim 1 further comprising two pivots, one of the pivots is inserted through the first pivot portion of the body and the first shaft portion of the first clamping member, and another one of the pivots is inserted through the second pivot portion of the body and the second shaft portion of the second clamping member.

8. The clamping device for clamping soft sheets as claimed in claim 7, wherein each of the pivots includes a head abutting against an outer surface of the body, an expanded portion connected to the head and inserted in the first pivot portion or the second pivot portion, and a rod portion connected to the expanded portion and inserted the first shaft portion of the first clamping member or the second shaft portion of the second clamping member.

9. The clamping device for clamping soft sheets as claimed in claim 7, wherein each of the pivots includes a head abutting against an outer surface of the body, a rod portion connected to the head and inserted in the first pivot portion of the body and the first shaft portion of the first clamping member or inserted in the second pivot portion of the body and the second shaft portion of the second clamping member, and a riveting portion connected to the rod portion and abutted against another outer surface of the body.
